(19) United States
(12) Patent Application Publication
(10) Pub. No.: US 2010/0267790 A1
(43) Pub. Date: Oct. 21, 2010

(54) Method, Use and Agent for Protecting a Plant Against Phakopsora

(75) Inventors: Dirk Voeste, Limburgerhof (DE); Egon Haden, Ludwigshafen (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/741,095

(22) PCT Filed: Nov. 4, 2008
(86) PCT No.: PCT/EP2008/064952

§ 371 Date: May 3, 2010

(30) Foreign Application Priority Data
Nov. 5, 2007 (EP) 07120019.0

(51) Int. Cl. A01N 43/653; A01P 1/00

(52) U.S. Cl. 514/384

(57) ABSTRACT

The present invention relates to a method for protecting a plant against a phytopathogen selected from the genus Phakopsora, wherein the seed of the plant is treated with (a) prothioconazole or a salt or adduct thereof and (b) trifloxystrobin or a salt or adduct thereof.

The present invention relates to a method, use and agent for protecting a plant against a phytopathogen selected from the genus Phakopsora, especially for controlling rust disease on soybean plants.

EP 460 575 describes methyl (E)-methoxyimino-{(E)-α-[1-(α,α,α-trifluoro-m-tolyl)ethylideneaminooxy]-o-tolyl}acetate (trifloxystrobin), its preparation and use as fungicide.

WO 96/16048 describes 2-[2-(1-chlorocyclopropyl)-3-(2-chlorophenyl)-2-hydroxypropyl]-2,4-dihydro-[1,2,4]triazol-3-thione (prothioconazole), its preparation and use as fungicide.

WO 2004/00021 describes the combined use of trifloxystrobin and prothioconazole for controlling cereal diseases, such as Erysiphe, Cochliobolus, Pyrenophora, Rhynchosporium, Septoria, Fusarium, Pseudocercosporella and Leptosphaeria; fungal infections of non-cereal crops such as vine, fruits, groundnuts, vegetables, for example Phythophthora, Plasmopara, Pythium, and powdery mildew fungi, such as, for example, Sphaerotheca or Uncinula; and causative organisms of leaf spot, such as Venturia, Alternaria and Septoria, and also Rhizoctonia, Botrytis, Sclerotinia and Sclerotium.

WO 2003/073852 describes the combined use of trifloxystrobin and prothioconazole for controlling the following phytopathogenic fungi: Blumeria graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugar cane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and Fusarium and Verticillium species.

Simplified crop rotation, relatively sensitive high-yield crop varieties and a desired rapid growth along with adverse weather conditions of high humidity have favoured an increased occurrence of other pathogenic fungi, such as Phakopsora, over recent years.

For instance, in 2001 and 2002, South America saw increasingly serious rust diseases in soybean cultures caused by the harmful fungi Phakopsora pachyrhizi and Phakopsora meibomiae. The results were considerable harvest and yield losses especially with seedlings.

Most current fungicides are not suitable for controlling rust diseases in soybean cultures because they do not sufficiently inhibit the multiplication of the harmful fungi which cause the rust disease, such as Phakopsora pachyrhizi and Phakopsora meibomiae. Moreover, there is a risk of the fungicidal active ingredient adversely affecting the symbiosis of root nodule bacteria (Rhizobium and Bradyrrhizobium) and legumes (Fabaceae), thus causing yield loss.

It was an object of the present invention to provide a method for the protection of crops from damage by a phytopathogen selected from the genus Phakopsora.

Surprisingly, it has now been found that said harmful fungi can efficiently be controlled and thus the disease on certain crops which is caused by these harmful fungi can be controlled by treating the seed of said plants with prothioconazole and trifloxystrobin.

Accordingly, the invention relates to a method for protecting a plant against a phytopathogen selected from the genus Phakopsora, which method comprises treating the seed of the plant with (a) prothioconazole or a salt or adduct thereof and (b) trifloxystrobin or a salt or adduct thereof.

The invention also relates to the use of (a) prothioconazole or a salt or adduct thereof and (b) trifloxystrobin or a salt or adduct thereof for protecting a plant against a phytopathogen selected from the genus Phakopsora.

The invention further relates to an agent for treating seed of a plant for protecting the plant against a phytopathogen selected from the genus Phakopsora, the agent comprising (a) prothioconazole or a salt or adduct thereof and (b) trifloxystrobin or a salt or adduct thereof.

Prothioconazole (component a) is a known fungicide from the group of the triazoles, i.e., 2-[2-(1-chlorocyclopropyl)-3-(2-chlorophenyl)-2-hydroxypropyl]-2,4-dihydro-[1,2,4]triazol-3-thione of the formula (I):

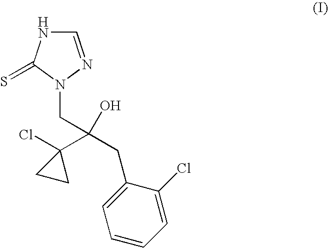

According to a particular embodiment, prothioconazole is the essentially enantiomerically pure compound of the formula I—R, or the essentially enantiomerically pure compound of the formula I—S

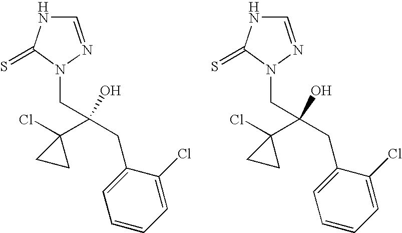

or a mixture of both enantiomers, e.g. the racemic mixture.

In the context of the present invention, “essentially enantiomerically pure compounds of the formula I—R or I—S” is to be understood as meaning that these compounds are present in an enantiomeric purity of in each case at least 85% ee, preferably at least 90% ee, particularly preferably at least 95% ee, more preferably at least 96% ee, even more preferably at least 97% ee and in particular at least 98% ee, for example at least 99% ee.

Trifloxystrobin (component b) is a known fungicide from the group of the strobilurines, i.e., methyl (E)-methoxyimino-{(E)-α-[1-(α,α,α-trifluoro-m-tolyl)ethylideneaminooxy]-o-tolyl}acetate of the formula (II):

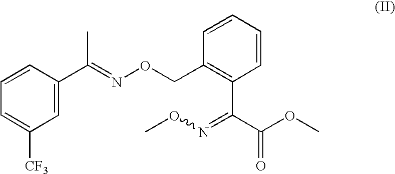

Owing to the basic character of their nitrogen atoms, prothioconazole and trifloxystrobin are capable of forming salts or adducts with inorganic or organic acids or with metal ions.

Examples of inorganic acids are hydrohalic acids, such as hydrogen fluoride, hydrogen chloride, hydrogen bromide and hydrogen iodide, sulfuric acid, phosphoric acid and nitric acid.

Suitable organic acids are, for example, formic acid, carbonic acid and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl radicals of 1 to 20 carbon atoms), arylsulfonic acids or aryldisulfonic acids (aromatic radicals, such as phenyl and naphthyl, which carry one or two sulfonic acid groups), alkylphosphonic acids (phosphonic acids having straight-chain or branched alkyl radicals of 1 to 20 carbon atoms), arylphosphonic acids or aryldiphosphonic acids (aromatic radicals, such as phenyl and naphthyl, which carry one or two phosphonic acid radicals), it being possible for the alkyl or aryl radicals to carry further substituents, for example as in p-toluenesulfonic acid, salicylic acid, p-aminosalicylic acid, 2-phenoxybenzoic acid, 2-acetoxybenzoic acid, etc.

Suitable metal ions are in particular the ions of the elements of the second main group, in particular calcium and magnesium, of the third and fourth main group, in particular aluminum, tin and lead, and of the first to eighth transition group, in particular chromium, manganese, iron, cobalt, nickel, copper, zinc and others. Particular preference is given to the metal ions of the elements of the transition groups of the fourth period. The metals can be present in the various valencies that they can assume.

Preferably, the salts and adducts are agriculturally acceptable salts and adducts.

Suitable agriculturally acceptable salts of prothioconazole or trifloxystrobin include in particular the acid addition salts. Acid anions of suitable acid addition salts are, in particular, chloride, bromide, fluoride, hydrogen sulfate, sulfate, dihydrogen phosphate, hydrogen phosphate, phosphate, nitrate, bicarbonate, carbonate, hexafluorosilicate, hexafluorophosphate, benzoate and the anions of C₁-C₄-carboxylic acids, such as formate, acetate, propionate and butyrate.

Processes for preparing prothioconazole are known in principle and described, for example, in WO 96/16048, the entire content of which is expressly incorporated herein by way of reference. The acid addition salts of prothioconazole can be prepared by reacting prothioconazole with an acid of the corresponding acid anion.

Processes for preparing trifloxystrobin are known in principle and described, for example, in EP 460 575, the entire content of which is expressly incorporated herein by way of reference. The acid addition salts of trifloxystrobin can be prepared by reacting trifloxystrobin with an acid of the corresponding acid anion.

For short, the binary combination consisting of (a) prothioconazole or a salt or adduct thereof and (b) trifloxystrobin or a salt or adduct thereof is hereinafter referred to as the prothio/trifloxy combination.

According to the invention, the seed treatment protects against a phytopathogen selected from the genus Phakopsora, including but not limited to Phakopsora meibomiae and Phakopsora pachyrhizi, which represent harmful fungi.

There are particular advantages with respect to the protection of beans (common name for large plant seeds of several genera of Fabaceae), including but not limited to Vicia sp. (e.g. Vicia faba), Vigna sp. (e.g. Vigna aconitifolia, Vigna angularis, Vigna mungo, Vigna radiate, Vigna umbellatta, Vigna unguiculata), Cicer sp. (e.g. Cicer arietinum), Pisum sp. (e.g. Pisum sativum), Lathyrus sp. (e.g. Lathyrus sativus, Lathyrus tuberosus), Lens sp. (e.g. Lens culinaris), Lablab sp. (e.g. Lablab purpureus), Phaseolus sp. (e.g. Phaseolus acutifolius, Phaseolus coccineus, Phaseolus lunatus, Phaseolus vulgaris), Glycine sp. (e.g. Glycine max), Psophocarpus sp. (e.g. Psophocarpus tetragonolobus), Cajanus sp. (e.g. Cajanus cajan), Stizolobium sp., Cyamopsis sp. (e.g. Cyamopsis tetragonoloba), Canavalia sp. (e.g. Canavalia ensiformis, Canavalia gladiata), Macrotyloma sp. (e.g. Macrotyloma uniflorum), Lupinus sp. (e.g. Lupinus mutabilis, Lupinus erythrina). According to a particular embodiment of the invention the seed to be treated is Pisum sativum (pea), Glycine max (soybean), Lens culinaris (lentil), Phaseolus vulgaris (common bean) or Vicia faba (broad bean).

According to a particular aspect, the seed treatment protects against a disease that may be caused by said phytopathogens, including but not limited to, soybean rust caused by Phakopsora spp, in particular Phakopsora meibomiae and Phakopsora pachyrhizi.

One purpose of said seed treatment is to control said phytopathogen. The treatment protects not only the seed during storage and sowing and up to germination, but also the plants during germination and thereafter, preferably for longer than the emergence phase, particularly preferably for at least eight weeks after sowing and again particularly preferably for at least four weeks after sowing.

Such a seed treatment thus involves a fungicidal effect or a fungicidal activity providing protection against damage done by said fungi to a seed and/or a plant grown from the seed.

As used herein, the terms “fungicidal effect” and “fungicidal activity” mean any direct or indirect action on the target fungus that results in reduction of damage on the treated seeds as well as on the plants or their parts (fruits, roots, shoots and/or foliage) grown from treated seeds as compared to untreated seeds or to plants grown from untreated seeds, respectively. The term “active against a fungus” also has the same meaning. Such direct or indirect actions include killing the fungus, and inhibiting or preventing reproduction of the fungus.

Surprisingly, the prothio/trifloxy combination according to the invention has a better fungicidal activity against the harmful fungi than would have been expected based on the fungicidal activity of the individual compounds, i.e. the fungicidal activity is increased in a superadditive manner. This means that, by using the prothio/trifloxy combination, an enhanced activity against harmful fungi in the sense of a synergetic effect (synergism) is achieved. For this reason, the combinations may be employed at lower total application rates.

According to the invention, the prothio/trifloxy combination comprises prothioconazole or a salt or adduct thereof and trifloxystrobin or a salt or adduct thereof in a weight ratio of usually from 200:1 to 1:200, more preferably from 100:1 to 1:100, particularly preferably from 50:1 to 1:50 and especially from 10:1 to 1:10. Preferably, the weight ratio is such that a synergistic effect takes place when the combination is applied.

Prothioconazole or the salt or adduct thereof and trifloxystrobin or the salt or adduct thereof can be applied jointly or separately. In the case of separate application, the application of the individual active ingredients can be simultaneously or—as part of a treatment sequence—one after the other, where the application in the case of successive application is preferably carried out at an interval of from a few minutes to a number of days.

Thus, the present invention also relates to agents which include both 1) compositions comprising (a) prothioconazole or a salt or adduct thereof and (b) trifloxystrobin or a salt or adduct thereof, as well as 2) kits comprising a first component which comprises prothioconazole or a salt or adduct thereof and a second component which comprises trifloxystrobin or a salt or adduct thereof, where the first and the second component are generally present in the form of separate compositions.

To widen the spectrum of action, the prothio/trifloxy combination can also be employed together with other active ingredients which are used in growing the plants described herein, for example together with avicides, acaricides, desiccants, bactericides, chemosterilants, defoliants, antifeedants, fungicides, herbicides, herbicide safeners, insect attractants, insecticides, insect repellents, molluscicides, nematicides, mating disrupters, plant activators, plant growth regulators, rodenticides, mammal repellents, synergists, bird repellents and virucides.

When the prothio/trifloxy combination is employed jointly with a further pesticidal active ingredient, the latter can be applied simultaneously with the prothio/trifloxy combination, beforehand or after a short time interval, for example within a few days before or after the prothio/trifloxy combination treatment. In the case of simultaneous application, the treatment of the seed can be effected in one pass where a composition comprising the prothio/trifloxy combination and the further fungicidal active ingredient are applied, or else in separate passes where different compositions of the individual active ingredients are applied. Said further pesticidal active ingredient may be incorporated into the composition which comprises prothioconazole or trifloxystrobin or both. Alternatively, said further pesticidal active ingredient may be present in the form of a separate composition that is included in the kit described above.

However, according to a particular embodiment, the prothio/trifloxy combination of the invention is not used in conjunction with a further fungicide and, according to a further particular embodiment, the prothio/trifloxy combination of the invention is not used in conjunction with a further pesticide.

As used herein, a “composition” comprises at least two ingredients, e.g., one active ingredient and at least one auxiliary agent.

As used herein, ingredients include active ingredients and auxiliary agents.

In the present invention, an “active ingredient” is a compound or a combination of compounds which directly exerts a biologically relevant effect, preferably a pesticidal and in particular a fungicidal effect as described herein. Prothioconazole, trifloxystrobin and their salts or adducts are active ingredients according to the present invention.

The term “auxiliary agent” refers to a compound or combination of compounds which do not exert a biologically relevant effect of their own, but support the effects of the active ingredient(s). When auxiliary agents are used, their choice will depend on the active ingredients and on the procedures selected for seed treatment.

Usually, the compositions thus comprise an active ingredient component (“A”) and an auxiliary agent component (“B”). The active ingredient component (“A”) of the composition comprises the prothioconazole and/or trifloxystrobin combination (“A1”) and optionally one or more further active ingredient(s) (“A2”). The auxiliary agent component (“B”) comprises one or more auxiliary agent(s).

Unless indicated otherwise, all amounts in % by weight refer to the weight of the total composition (or formulation).

In general, the compositions comprise from 0.005% by weight to 95% by weight, preferably from 0.1% by weight to 90% by weight, in particular from 5% by weight to 50% by weight, of the active ingredient component “A”, the balance being formed by component “B”. In this context, the active ingredients are employed in a purity of 90% to 100%, preferably 95% to 100% (according to NMR spectrum). According to a particular embodiment, component “A” essentially consists of prothioconazole, a salt or adduct thereof and/or trifloxystrobin, a salt or adduct thereof, i.e. the active ingredients of the composition are represented by prothioconazole, a salt or adduct thereof, trifloxystrobin, a salt or adduct thereof, or the prothio/trifloxy combination.

The present invention relates to seed treatment and thus the compositions of the invention are preferably seed treatment compositions. A seed treatment composition according to the present invention comprises at least one auxiliary agent that is specifically suited for the seed treatment, i.e. an auxiliary agent which in particular promotes adhesion of the active ingredient to and/or penetration into the seeds and/or otherwise improves stability and/or manageability of the composition or the seeds treated therewith. Thus, the seed treatment composition the present invention comprises at least one seed treatment auxiliary agent(s), and optionally one or more further auxiliary agents.

In particular, seed treatment auxiliary agents are selected from the group consisting of agents suitable for seed coating materials, agents suitable for solid matrix priming materials, penetration enhancers suitable for promoting seed imbibition, colorants, antifreezes, and gelling agents.

According to a preferred embodiment, the seed coating material comprises a binder (or sticker). Optionally, the coating material also comprises one or more additional seed treatment auxiliary agents selected from the group consisting of fillers and plasticizers.

Binders (or stickers) are all customary binders (or stickers) which can be employed in seed treatment compositions. Binders (or stickers) that are useful in the present invention preferably comprise an adhesive polymer that may be natural or partly or wholly synthetic and is without phytotoxic effect on the seed to be coated. Preferably, the binder (or sticker) is biodegradable.

The binder (or sticker) may be selected from polyesters, polyether esters, polyanhydrides, polyester urethanes, polyester amides; polyvinyl acetates; polyvinyl acetate copolymers; polyvinyl alcohols and tylose; polyvinyl alcohol copolymers; polyvinylpyrolidones; polysaccharides, including starches, modified starches and starch derivatives, dextrins, maltodextrins, alginates, chitosanes and celluloses, cellulose esters, cellulose ethers and cellulose ether esters including ethylcelluloses, methylcelluloses, hydroxymethylcelluloses, hydroxypropylcelluloses and carboxymethylcellulose; fats; oils; proteins, including casein, gelatin and zeins; gum arabics; shellacs; vinylidene chloride and vinylidene chloride copolymers; lignosulfonates, in particular calcium lignosulfonates; polyacrylates, polymethacrylates and acrylic copolymers; polyvinylacrylates; polyethylene oxide; polybutenes, polyisobutenes, polystyrene, polyethyleneamines, polyethylenamides; acrylamide polymers and copolymers; polyhydroxyethyl acrylate, methylacrylamide monomers; and polychloroprene. In a particular embodiment, the binder is a thermoplastic polymer.

In a particular embodiment of the invention the seed treatment composition contains at least one polyester, which, in particular, is selected from polylactides, partially aromatic polyesters (copolymers of terephthalic acid, adipic acid and aliphatic diols), polyglycolides, polyhydroxyalkanoates and polytartrates.

The amount of binder (or sticker) in the composition can vary, but, if present, will be in the range of about 0.01 to about 25% of the total weight, more preferably from about 1 to about 15%, and even more preferably from about 5% to about 10%.

As mentioned above, the coating material can optionally also comprise a filler. The filler can be an absorbent or an inert filler, such as are known in the art, and may include wood flours, cereal flours, tree bark mill, wood meal and nut shell meal, sugars, in particular polysaccharides, activated carbon, fine-grain inorganic solids, silica gels, silicates, clays, chalk, diatomaceous earth, calcium carbonate, magnesium carbonate, dolomite, magnesium oxide, calcium sulfate and the like. Clays and inorganic solids which may be used include calcium bentonite, kaolin, china clay, talc, perlite, mica, vermiculite, silicates, quartz powder, montmorillonite, attapulgite, bole, loess, limestone, lime and mixtures thereof. Sugars which may be useful include dextrin and maltodextrin. Cereal flours include wheat flour, oat flour and barley flour. The filler may also comprise fertilizer substances such as, for example, ammonium sulfate, ammonium phosphate, ammonium nitrate, ureas and mixtures thereof.

The filler is selected so that it will provide a proper microclimate for the seed, for example the filler is used to increase the loading rate of the active ingredients and to adjust the control-release of the active ingredients. The filler can aid in the production or process of coating the seed. The amount of filler can vary, but generally the weight of the filler components, if present, will be in the range of about 0.05 to about 75% of the total weight, more preferably about 0.1 to about 50%, and even more preferably about 0.5% to 15%.

It is preferred that the binder (or sticker) be selected so that it can serve as a matrix for the active ingredient(s). While the binders disclosed above may all be useful as a matrix, it is preferred that a continuous solid phase of one or more binder compounds is formed throughout which is distributed as a discontinuous phase the active ingredient(s). Optionally, a filler and/or other components can also be present in the matrix. The term “matrix” is to be understood to include what may be viewed as a matrix system, a reservoir system or a microencapsulated system. In general, a matrix system consists of the active ingredient(s) and a filler uniformly dispersed within a polymer, while a reservoir system consists of a separate phase comprising the active ingredient(s) that is physically dispersed within a surrounding, rate-limiting, polymeric phase. Microencapsulation includes the coating of small particles or droplets of liquid, but also to dispersions in a solid matrix.

Especially if the active ingredient(s) used in the coating is an oily type composition and little or no inert filler is present, it may be useful to hasten the drying process by drying the composition. This optional step may be accomplished by means well known in the art and can include the addition of fillers such as calcium carbonate, kaolin or bentonite clay, perlite, diatomaceous earth, or any absorbent material that is added preferably concurrently with the active ingredient(s) coating layer to absorb the oil or excess moisture. The amount of absorbent necessary to effectively provide a dry coating will be in the range of about 0.5 to about 10% of the weight of the seed.

Optionally, the coating material comprises a plasticizer. Plasticizers are typically used to make the film that is formed by the coating layer more flexible, to improve adhesion and spreadability, and to improve the speed of processing. Improved film flexibility is important to minimize chipping, breakage or flaking during storage, handling or sowing processes. Many plasticizers may be used; however, useful plasticizers include polyethylene glycol, oligomeric polyalkylene glycols, glycerol, alkylbenzylphthalates, in particular butylbenzylphthalate, glycol benzoates and related compounds. The amount of plasticizer, if present, in the coating layer will be in the range of from about 0.1% by weight to about 20% by weight.

Agents suitable for solid matrix priming materials which are useful in the present invention include polyacrylamide, starch, clay, silica, alumina, soil, sand, polyurea, polyacrylate, or any other material capable of absorbing or adsorbing the active ingredient(s) and releasing the active ingredient(s) into or onto the seed. It is useful to make sure that active ingredient(s) and the solid matrix material are compatible with each other. For example, the solid matrix material should be chosen so that it can release the active ingredient(s) at a reasonable rate, for example over a period of minutes, hours, or days.

Penetration enhancers suitable for promoting seed imbibition include agriculturally acceptable surface active compounds. The amount of penetration enhancers will usually not exceed 20% by weight, based on the total weight of the composition. Preferably, the amount of penetration enhancers, if present, will be in the range from 2% to 20% by weight.

Colorants according to the invention are all dyes and pigments which are customary for such purposes. In this context, both pigments, which are sparingly soluble in water, and dyes, which are soluble in water, may be used. Examples which may be mentioned are the colorants, dyes and pigments known under the names Rhodamin B, C. I. Pigment Red 112 and C. I. Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108. The amount of colorants will usually not exceed 20% by weight of the composition and, if present, preferably ranges from 1 to 15% by weight, based on the total weight of the composition. It is generally preferred if the colorants are also active as repellents for warm-blooded animals, e.g. iron oxide, TiO₂, Prussian blue, anthraquinone dyes, azo dyes and metal phtalocyanine dyes.

Antifreezes which can be employed especially for aqueous compositions are in principle all those substances which lead to a depression of the melting point of water. Suitable antifreezes comprise alcohols such as methanol, ethanol, isopropanol, butanols, glycol, glycerine, diethylenglycol and the like. Typically, the amount of antifreeze will not exceed 20% by weight and, if present, frequently ranges from 1 to 15% by weight, based on the total weight of the composition.

Gelling agents which are suitable are all substances which can be employed for such purposes in agrochemical compositions, for example cellulose derivatives, polyacrylic acid derivatives, xanthan, modified clays, in particular organically modified phyllosilicates and highly-dispersed silicates. A particularly suitable gelling agent is carrageen (Satiagel®). Usually, the amount of gelling agent will not exceed 5% by weight of the composition and, if present, preferably ranges from 0.5 to 5% by weight, based on the total weight of the composition.

Further auxiliary agents that may be present in the seed treatment composition include solvents, wetters, dispersants, emulsifiers, surfactants, thickeners, protective colloids, antifoams, and preservatives.

Examples of suitable solvents are water or organic solvents such as aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used. However, according to a particular embodiment, the compositions of the present invention contain less than 10% by weight and preferably less than 6% by weight of said organic solvents.

Surface active compounds are all those surfactants which are suitable for formulating agrochemical actives, in particular for active ingredient(s), and which may be nonionic, cationic, anionic or amphoteric. According to their action, surfactants—sometimes referred to as “additives”—may be divided into wetters, dispersants, emulsifiers or protective colloids; however, these particular groups may overlap and cannot be divided strictly. Typically, the amount of surfactants will not exceed 20% by weight and, if present, frequently ranges from 1 to 15% by weight, based on the total weight of the composition.

Suitable wetters are all those substances which promote wetting and which are conventionally used for formulating agrochemical active ingredients. Alkylnaphthalenesulfonates such as diisopropyl- or diisobutylnaphthalenesulfonates can be used preferably.

Dispersants and/or emulsifiers which are suitable are all nonionic, anionic and cationic dispersants or emulsifiers conventionally used for formulating agrochemical active ingredients. The following can preferably be used: nonionic or anionic dispersants and/or emulsifiers or mixtures of nonionic or anionic dispersants and/or emulsifiers.

Suitable nonionic dispersants and/or emulsifiers which may be employed are, in particular, ethylene oxide/alkylene oxide block copolymers, alkylphenol polyglycol ethers and tristryrylphenol polyglycol ethers, for example polyoxyethylene octylphenol ether, ethoxylated isooctylphenol, octylphenol, nonylphenol, alkylphenol polyglycol ether, tributylphenyl polyglycol ether, tristearylphenyl polyglycol ether, alkylarylpolyether alcohols, alcohol and fatty alcohol ethylene oxide condensates, ethoxylated castor oil, polyoxyethylene alkyl ether, ethoxylated polyoxypropylene, lauryl alcohol polyglycol ether acetal, sorbitol esters and methyl cellulose.

Suitable anionic dispersants which and/or emulsifiers which may be employed are, in particular, alkali metal, alkaline earth metal and ammonium salts of ligninsulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore arylsulfonate/formaldehyde condensates, for example condensates of sulfonated naphthalene and naphthalene derivatives with formaldehyde, condensates of naphthalene or of naphthalenesulfonic acid with phenol and formaldehyde, ligninsulfonates, lignin-sulfite waste liquors, phosphated or sulfated derivatives of methylcellulose, and salts of polyacrylic acid.

Thickeners are typically water-soluable polymers which exhibit suitable plastic properties in an aqueous medium. Examples include gum arabic, gum karaya, gum tragacanth, guar gum, locust bean gum, xanthan gum, carrageenan, alginate salt, casein, dextran, pectine, argar, 2-hydroxyethyl starch, 2-aminoethyl starch, 2-hydroxyethyl cellulose, methyl cellulose, carboxymethyl cellulose salt, cellulose sulfate salt. Xanthan gum is preferred. Usually, the amount of thickener will not exceed 20% by weight and, if present, frequently ranges from 1 to 15% by weight, based on the total weight of the composition.

Protective colloids are typically water soluble, amphiphilic polymers. Examples include proteins and denatured proteins such as casein, polysaccharides such as water soluble starch derivatives and cellulose derivatives, in particular hydrophobic modified starch and celluloses, furthermore polycarboxylates such as polyacrylic acid and acrylic acid copolymers, polyvinylalcohol, polyvinylpyrrolidone, vinylpyrrolidone copolymers, polyvinyl amines, polyethylene imines and polyalkylene ethers. Usually, the amount of protective colloid will not exceed 3% by weight of the composition and, if present, preferably ranges from 0.1 to 2% by weight, based on the total weight of the composition.

Antifoams which can be employed are all those substances which inhibit the development of foam and which are conventionally used for formulating agrochemical active ingredients. Silicone antifoams, i.e. aqueous silicon emulsions (e.g. Silikon® SRE by Wacker or Rhodorsil® by Rhodia), long chain alcohols, fatty acids and salts thereof, e.g. and magnesium stearate are particularly suitable. Usually, the amount of antifoam will not exceed 3% by weight of the composition and, if present, preferably ranges from 0.1 to 2% by weight, based on the total weight of the composition.

Preservatives which can be employed are all preservatives used for such purposes in agrochemical compositions. Examples which may be mentioned are dichlorophene, isothiazolenes and isothiazolones such as 1,2-benzisothiazol-3(2H)-one, 2-methyl-2H-isothiazol-3-one-hydrochloride, 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one-hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one-calcium chloride complex, 2-octyl-2H-isothiazol-3-one and benzyl alcohol hemiformal. Usually, the amount of preservatives will not exceed 2% by weight of the composition and, if present, preferably ranges from 0.01 to 1% by weight, based on the total weight of the composition.

In a particular embodiment of the invention, the composition may comprise one or more repellents for warm-blooded animals, e.g. birds, dogs and hedgehogs, for example nonanoic acid vanillyl amide. The amount of repellent, if present, will preferably range from 0.1 to 5% by weight, based on the total weight of the composition.

The skilled person is essentially familiar with agricultural compositions of active ingredients (see, for instance, Ullmann's Encyclopedia of Industrial Chemistry, Fungicides Chapter 4, 5th ed. on CD-ROM, Wiley-VCH, 1997 and Mollet, H., Grubemann, A., Formulation technology, Wiley VCH Verlag GmbH, Weinheim (Federal Republic of Germany), 2001, which is incorporated by reference in its entirety. Examples include water-soluble concentrates (SL, LS), dispersible concentrates (DC), emulsifiable concentrates (EC), emulsions (EW, EO, ES), suspensions (SC, OD, FS), water-dispersible granules (WG, SG), water-dispersible or water-soluble powders (WP, SP, SS, WS), dusts or dustable powders (DP, DS), granules (GR, FG, GG, MG), ULV solutions (UL) and gel formulations (GF). For seed treatment purposes, such compositions may be applied as such or after addition of a suitable liquid, in particular water, in order to dissolve, emulsify, disperse, suspend or dilute the composition. The type of the ready-to-use preparation applied to the seeds thus depends on the type of composition used and the method used for treating the seeds.

The compositions can be prepared in the known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), all of which being incorporated by reference in its entirety) for example by extending the active ingredient component with one or more auxiliary agents.

The following formulations simply illustrate said compositions:

### A Water-Soluble Concentrates, Solutions (SL, LS)

10 parts by weight of the active ingredient(s) and, optionally, wetters or other auxiliaries are dissolved in 90 parts by weight of water or a water-soluble solvent, whereby a formulation with 10% (w/w) of the active ingredient(s) is obtained. Dilution with water gives a solution.

### B Dispersible Concentrates (DC)

20 parts by weight of the active ingredient(s) are dissolved in 70 parts by weight of cyclohexanone with addition of 10 parts by weight of a dispersant, for example polyvinylpyrrolidone, whereby a formulation with 20% (w/w) of the active ingredient(s) is obtained. Dilution with water gives a dispersion.

### C Emulsifiable Concentrates (EC)

15 parts by weight of the active ingredient(s) are dissolved in 70 parts by weight of an organic solvent with addition of calcium dodecylbenzenesulfonate and castor oil ethoxylate (in each case 5 parts by weight), whereby a formulation with 15% (w/w) of the active ingredient(s) is obtained. Dilution with water gives an emulsion.

### D Emulsions (EW, EO, ES)

25 parts by weight of the active ingredient(s) are dissolved in 35 parts by weight of an organic solvent with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion, whereby a formulation with 25% (w/w) of the active ingredient(s) is obtained. Dilution with water gives an emulsion.

### E Suspensions (SC, OD, FS)

In an agitated ball mill, 20 parts by weight of the active ingredient(s) are comminuted with addition of 10 parts by weight of dispersant(s) and/or wetter(s) and 70 parts by weight of water or of an organic solvent to give a fine active compound(s) suspension, whereby a formulation with 20% (w/w) of the active ingredient(s) is obtained. Dilution with water gives a stable suspension of the active ingredient(s).

### F Water-Dispersible Granules (WG, SG)

50 parts by weight of the active ingredient(s) are ground finely with addition of 50 parts by weight of dispersant(s) and/or wetter(s) and made as water-dispersible or water-soluble granules by means of technical appliances (for example extrusion, spray tower, fluidized bed), whereby a formulation with 50% (w/w) of the active ingredient(s) is obtained. Dilution with water gives a stable dispersion or solution of the active compound(s).

### G Water-Dispersible and Water-Soluble Powders (WP, SP, SS, WS)

75 parts by weight of the active ingredient(s) are ground in a rotor-stator mill with addition of 25 parts by weight of dispersant(s) and/or wetter(s), and silica gel, whereby a formulation with 75% (w/w) of the active ingredient(s) is obtained. Dilution with water gives a stable dispersion or solution of the active ingredient(s).

### H Gel Formulation (GF)

In an agitated ball mill, 20 parts by weight of the active ingredient(s) are comminuted with addition of 10 parts by weight of dispersant(s), 1 part by weight of a gelling agent and 70 parts by weight of water or of an organic solvent to give a fine active compound(s) suspension, whereby a formulation with 20% (w/w) of the active ingredient(s) is obtained. Dilution with water gives a stable suspension of the active ingredient(s).

### I Dusts and Dustable Powders (DP, DS)

5 parts by weight of the active ingredient(s) are ground finely and mixed intimately with 95 parts by weight of finely divided kaolin. This gives a dustable product having 5% (w/w) of the active ingredient(s).

### J Granules (GR, FG, GG, MG),

0.5 part by weight of the active ingredient(s) is ground finely and associated with 95.5 parts by weight of carriers, whereby a formulation with 0.5% (w/w) of the active ingredient(s) is obtained. Current methods are extrusion, spray-drying or the fluidized bed.

### K ULV Solution (UL)

10 parts by weight of the active ingredient(s) are dissolved in 90 parts by weight of an organic solvent. This gives a product having 10% (w/w) of the active ingredient(s).

Formulations A-K can be diluted with water before application or directly applied.

According to a particular embodiment of present invention, the seed treatment composition is a liquid or is applied as a liquid. Preference is given to a suspension and especially an aqueous suspension. The suspended particles are active ingredient(s) or auxiliary agents having a melting point above 30° C.

For the seed treatment according to the present invention, powders, such as water-dispersible, water-soluble and dustable powders, dusts and suspensions are preferred. Further, gel formulations are preferred. Also, water-soluble concentrates and emulsions may be expediently used.

According to the present invention, the following formulations are particularly preferred: flowable concentrates (especially FS); solutions (especially LS); powders for dry treatment (especially DS); water dispersible powders for slurry treatment (especially WS); water-soluble powders (especially SS) and emulsions (especially ES). Also preferred are gel formulations (especially GF). These formulations can be applied to the seed diluted or undiluted.

According to a particular embodiment, the invention relates to a FS formulation. Typically, a FS formulation may comprise 1-800 g/l of the active ingredient(s), 1-200 g/l dispersant, 0 to 200 g/l antifreezing agent, 0 to 400 g/l of binder, 0 to 200 g/l of a colorant and up to 1 liter of a solvent, preferably water.

According to a further particular embodiment, the seed treatment composition of the present invention is a seed coating formulation.

Such seed coating formulations comprise the active ingredient(s), at least one binder (or sticker) and optionally at least one further auxiliary agent that is selected from the group consisting of fillers and plasticizers.

Seed coating formulations comprising binders, fillers and/or plasticizers are well-known in the art. Seed coating formulations are disclosed, for example, in U.S. Pat. Nos. 5,939,356, 5,882,713, 5,876,739, 5,849,320, 5,834,447, 5,791,084, 5,661,103, 5,622,003, 5,580,544, 5,328,942, 5,300,127, 4,735,015, 4,634,587, 4,383,391, 4,372,080, 4,339,456, 4,272,417 and 4,245,432, among others.

The amount of the active ingredient(s) that is included in the coating formulation will vary depending upon the type of seed, but the coating formulation will contain an amount of the active ingredient(s) that is pesticidally effective. In general, the amount of the active ingredient(s) in the coating formulation will range from about 0.005 to about 75% of the total weight. A more preferred range for the active ingredient(s) is from about 0.01 to about 40%; more preferred is from about 0.05 to about 20%.

The exact amount of the active ingredient(s) that is included in the coating formulation is easily determined by one skilled in the art and will vary depending upon the size and other characteristics (surface structure etc.) of the seed to be coated. The active ingredient(s) of the coating formulation must not inhibit germination of the seed and should be efficacious in protecting the seed and/or the plant during that time in the target pest's life cycle in which it causes injury to the seed or plant. In general, the coating will be efficacious for approximately 0 to 120 days, preferably for approximately 0 to 60 days, after sowing.

The coating formulations formed with the active ingredient(s) are capable of effecting a slow rate of release of the active ingredient(s) by diffusion or movement through the matrix into the seed or to the surrounding medium.

The method of the present invention comprises applying an effective amount of the active ingredients to a lot of seeds.

In each embodiment of the invention, it is preferred that the active ingredients are applied to a seed in an effective amount, that is, an amount sufficient to provide protection against the fungus to the seed and/or the plant that grows from the seed. As used herein, “protection” is to be understood as meaning any measure or combination of measures which is suitable to reduce or completely prevent damage by said fungus. Here, “damage” includes any kind of qualitative and/or quantitative yield reduction (reduction of the number of germinating plants, the harvest yield, the fruit quality, etc.). Protection is to be considered as having been achieved when the damage of the treated seed and/or the plants grown therefrom is significantly reduced compared to that of the untreated seed and/or the plants grown therefrom. In order to be effective, the active ingredients are generally employed in an amount of from 1 to 500 g, preferably 10 to 200 g, per 100 kilograms of seed.

The term “batch” or “lot” means a group of seeds that are undergoing the seed treatment. The amount and weight of the seeds can vary depending on the treatment.

The term “loading” refers to the actual amount of an active ingredient that is adhered onto each seed, based on bulk amount of seed.

As used herein, the term “seed” denotes any resting stage of a plant that is physically detached from the vegetative stage of a plant and/or may be stored for prolonged periods of time and/or can be used to re-grow another plant individual of the same species. Here, the term “resting” refers to a state wherein the plant retains viability, within reasonable limits, in spite of the absence of light, water and/or nutrients essential for the vegetative (i.e. non-seed) state. In particular, the term refers to true seeds but does not embraces plant propagules such as suckers, corms, bulbs, fruit, tubers, grains, cuttings and cut shoots.

As used herein, the term “plant” means an entire plant or parts thereof. The term “entire plant” refers to a complete plant individual in its vegetative, i.e. non-seed stage, characterized by the presence of an arrangement of roots, shoots and foliage, depending on the developmental stage of the plant also flowers and/or fruits, all of which are physically connected to form an individual which is, under reasonable conditions, viable without the need for artificial measures. The term may also refer to an entire plant harvested as such.

The term “plant parts” refers to roots, shoots, foliage, flowers or other parts of the vegetative stage of the plant, which, when dislodged and disconnected from the rest, are incapable of survival, unless supported by artificial measures or able to re-grow the missing parts to form an entire plant. As used herein, fruits are also considered as plant parts.

As used herein, the term “root” refers to parts of a plant which are normally, in order to fulfill their physiological functions, located beneath the soil surface. Preferably, the term denotes the parts of a plant which are below the seed and have directly emerged from the latter, or from other roots, but not from shoots or foliage.

As used herein, the “shoots and foliage” of a plant are to be understood to be the shoots, stems, branches, leaves and other appendages of the stems and branches of the plant after the seed has sprouted, but not including the roots of the plant. It is preferable that the shoots and foliage of a plant be understood to be those non-root parts of the plant that have grown from the seed and are located a distance of at least one inch away from the seed from which they emerged (outside the region of the seed), and more preferably, to be the non-root parts of the plant that are at or above the surface of the soil.

As used herein, “fruits” are considered to be the parts of a plant which contain seeds and/or serve to spread seeds, and/or which may be removed from a plant without impairing its viability.

According to the present invention, the seed treatment comprises applying a composition of the invention to a seed. Although the present method can be applied to a seed in any physiological state, it is preferred that the seed be in a sufficiently durable state that it incurs no significant damage during the treatment process. Typically, the seed is a seed that has been harvested from the field; removed from the plant; and/or separated from the fruit and any cob, pod, stalk, outer husk, and surrounding pulp or other non-seed plant material. The seed is preferably also biologically stable to the extent that the treatment would cause no biological damage to the seed. In one embodiment, for example, the treatment can be applied to seed that has been harvested, cleaned and dried to a moisture content below about 15% by weight. In an alternative embodiment, the seed can be one that has been dried and then primed with water and/or another material and then re-dried before or during the treatment with a composition of the invention.

The term seed treatment comprises all suitable seed treatment and especially seed dressing techniques known in the art, such as seed coating (e.g. seed pelleting), seed dusting and seed imbibition (e.g. seed soaking). Here, “seed treatment” refers to all methods that bring seeds and a composition of the invention into contact with each other, and “seed dressing” to methods of seed treatment which provide the seeds with an amount of the active ingredient, i.e. which generate a seed comprising the active ingredient. In principle, the treatment can be applied to the seed at any time from the harvest of the seed to the sowing of the seed. The seed can be treated immediately before, or during, the planting of the seed, for example using the “hopper-box” or “planter-box” method. However, the treatment may also be carried out several weeks or months, for example up to 12 months, before planting the seed, for example in the form of a seed dressing treatment, without a substantially reduced efficacy being observed.

Expediently, the treatment is applied to unsown seed. As used herein, the term “unsown seed” is meant to include seed at any period from the harvest of the seed to the sowing of the seed in the ground for the purpose of germination and growth of the plant.

When it is said that unsown seed is “treated”, such treatment is not meant to include those practices in which the pesticide is applied to the soil, rather than directly to the seed.

By applying the treatment to the seed prior to the sowing of the seed the operation is simplified. In this manner, seeds can be treated, for example, at a central location and then dispersed for planting. This permits the person who plants the seeds to avoid the handling and use of the active ingredient and to merely handle and plant the treated seeds in a manner that is conventional for regular untreated seeds, which reduces human exposure.

Specifically, the seed treatment follows a procedure in which the seed is exposed to the specifically desired amount of a preparation comprising the active ingredient(s). The preparation may be a composition of the present invention that is applied as such or after previously diluting it, e.g. with water; for instance, it may be expedient to dilute seed treatment compositions 2-10 fold leading to concentrations in the ready-to-use compositions of 0.01 to 60% by weight active compound by weight, preferably 0.1 to 40% by weight.

Thus, the active ingredient concentrations in ready-to-use preparation can be varied within substantial ranges. In general, they are between in the range from 0.01 and 80% by weight, frequently in the range from 0.1 to 50% by weight, preferably in the range from 0.5 and 20% by weight, based on the total weight of the preparation. The active ingredients can also successfully be used in concentrated form, it being possible to apply, to the seed, preparations with more than 80% by weight of active ingredient, or even the active ingredient without additions. The amount of additives will generally not exceed 30% by weight, preferably 20% by weight, and is, in particular, in the range of from 0.1 to 20% by weight, in each case based on the total weight of the preparation.

Usually, a device which is suitable for seed treatment, for example a mixer for solid or solid/liquid components, is employed until the preparation is distributed uniformly on the seed. Thus, the preparation can be applied to seeds by any standard seed treatment methodology, including but not limited to mixing in a container (e.g., a bottle, bag or tumbler), mechanical application, tumbling, spraying, and immersion. If appropriate, this is followed by drying.

Particular embodiments of the present invention comprise seed coating and imbibition (e.g. soaking). “Coating” denotes any process that endows the outer surfaces of the seeds partially or completely with a layer or layers of non-plant material, and “imbibition” any process that results in penetration of the active ingredient(s) into the germinable parts of the seed and/or its natural sheath, (inner) husk, hull, shell, pod and/or integument. The invention therefore also relates to a treatment of seeds which comprises providing seeds with a coating that comprises the active ingredient(s), and to a treatment of seeds which comprises imbibition of seeds with the active ingredient(s).

Coating is particularly effective in accommodating high loads of the active ingredient(s), as may be required to treat typically refractory pests, while at the same time preventing unacceptable phytotoxicity due to the increased load of the active ingredient(s).

Coating may be applied to the seeds using conventional coating techniques and machines, such as fluidized bed techniques, the roller mill method, rotostatic seed treaters, and drum coaters. Other methods such as the spouted beds technique may also be useful. The seeds may be pre-sized before coating. After coating, the seeds are typically dried and then transferred to a sizing machine for sizing.

Such procedures are known in the art. Seed coating methods and apparatus for their application are disclosed in, for example, U.S. Pat. Nos. 5,918,413, 5,891,246, 5,554,445, 5,389,399, 5,107,787, 5,080,925, 4,759,945 and 4,465,017.

In another particular embodiment, the solid active ingredient(s), for instance as a solid fine particulate formulation, e.g. a powder or dust, can be mixed directly with seeds. Optionally, a sticking agent can be used to adhere the solid, e.g. the powder, to the seed surface. For example, a quantity of seed can be mixed with a sticking agent (which increases adhesion of the particles on the surface of the seed) and optionally agitated to encourage uniform coating of the seed with the sticking agent. For example, the seed can be mixed with a sufficient amount of sticking agent, which leads to a partial or complete coating of the seed with sticking agent. The seed pretreated in this way is then mixed with a solid formulation containing the active ingredient(s) to achieve adhesion of the solid formulation on the surface of the seed material. The mixture can be agitated, for example by tumbling, to encourage contact of the sticking agent with the active ingredient(s), thereby causing the solid the active ingredient(s) to stick to the seed.

Another particular method of treating seed with the active ingredient(s) is imbibition. For example, seed can be combined for a period of time with an aqueous solution comprising from about 1% by weight to about 75% by weight of the active ingredient(s) in a solvent such as water. Preferably the concentration of the solution is from about 5% by weight to about 50% by weight, more preferably from about 10% by weight to about 25% by weight. During the period that the seed is combined with the solution, the seed takes up (imbibes) at least a portion of the active ingredient(s). Optionally, the mixture of seed and solution can be agitated, for example by shaking, rolling, tumbling, or other means. After the imbibition process, the seed can be separated from the solution and optionally dried in a suitable manner, for example by patting or air-drying.

In yet another particular embodiment of the present invention, the active ingredient(s) can be introduced onto or into a seed by use of solid matrix priming. For example, a quantity of the active ingredient(s) thereof can be mixed with a solid matrix material, and then the seed can be placed into contact with the solid matrix material for a period to allow the active ingredient(s) to be introduced to the seed. The seed can then optionally be separated from the solid matrix material and stored or used, or, preferably, the mixture of solid matrix material plus seed can be stored or planted/sown directly.

The present invention also provides a seed that has been treated by the method described herein. It also provides a seed obtainable by the method described herein.

Further, the present invention also provides a seed that has been treated with the seed treatment composition described herein, and in particular that is coated with the composition or contains it. It also provides a seed obtainable by using the composition described herein.

According to a particular embodiment, the seeds treated with the composition of the present invention have a loading of active ingredient(s) of 1 to 500 g, preferably 10 to 200 g, per 100 kgs of seeds.

The term “coated with and/or contains” here signifies that the active ingredient(s) is for the most part on the surface of the seed at the time of application, although a greater or lesser part of the active ingredient(s) may penetrate into the seed, depending on the method of application. When the said seed is (re)planted, it may absorb the active ingredient(s).

According to one embodiment, such a seed comprising the active ingredient(s) has a coating, wherein the coating comprises the active ingredient(s). According to a further embodiment, such a seed comprising the active ingredient(s) is a seed whose germinable part and/or natural sheath, shell, pod and/or integument comprise(s) the active ingredient(s). Also, the active ingredient(s) can be present in both the coating and the germinable part and/or natural sheath, shell, pod and/or integument of the seed.

Preferably, such seeds comprise an effective amount of the active ingredient(s). Accordingly, the seeds are coated, impregnated or coated and impregnated in such a manner that pest damage during germination and emergence is reduced.

The seeds treated with the composition of the present invention may also be enveloped with a film overcoating to protect the coating containing the active ingredient(s). Such overcoatings are known in the art and may be applied using conventional fluidized bed and drum film coating techniques.

The seeds of the present invention can be used for the propagation of plants. The seeds can be stored, handled, planted/sowed and tilled.

The following examples illustrate the invention without limiting it.

### EXAMPLES

### Example 1

### Control of Soybean Rust Caused by Phakopsora pachyrhizi

Soybean seeds were treated with a conventional seed treatment formulation containing either prothioconazole or trifloxystrobin, or with a mixture thereof so that the desired amounts were applied per 100 kg of seed. The treated seeds were sown.

After incubation at 23 to 27° C. and a relative humidity between 60 and 80% for 14 days the plants will inoculated with an aqueous suspension of Phakopsora pachyrhizi. Then the plants will cultivated in a greenhouse chamber at 23 to 27° C. and a relative humidity between 60 and 80%.

After 10 days of cultivation, the extent of rust disease on the leaves will be visually assessed as % diseased leaf area.

The extent of disease will be converted into efficacies. An efficacy of 0 means that the infection level of the treated plants corresponds to that of the untreated control plants; an efficacy of 100 means that the treated plants were not infected. The expected efficacies of active compound mixtures will determined using Colby's formula [R. S. Colby, “Calculating synergistic and antagonistic responses of herbicide combinations”, Weeds 15, 20-22 (1967)] and compared with the observed efficacies. It is expected that the mixture of prothioconazole and trifloxystrobin is significantly more active than each compound alone.

1-10. (canceled)

11. A method for protecting a plant against a phytopathogen selected from the genus Phakopsora, comprising treating the seed of the plant with (a) prothioconazole or a salt or adduct thereof and (b) trifloxystrobin or a salt or adduct thereof.

12. The method according to claim 11, wherein the plant is selected from the group consisting of Pisum sativum (pea), Glycine max (soybean), Lens culinaris (lentil), Phaseolus vulgaris (common bean) and Vicia faba (broad bean).

13. The method according to claim 12, wherein the plant is a soybean.

14. The method according to claim 11, wherein the Phakopsora species is Phakopsora meibomiae or Phakopsora pachyrhizi.

15. The method according to claim 12, wherein the Phakopsora species is Phakopsora meibomiae or Phakopsora pachyrhizi.

16. The method according to claim 13, wherein the Phakopsora species is Phakopsora meibomiae or Phakopsora pachyrhizi.

17. An agent for treating seed of a plant for protecting the plant against a phytopathogen selected from the genus Phakopsora, the agent comprising (a) prothioconazole or a salt or adduct thereof and (b) trifloxystrobin or a salt or adduct thereof.

18. The agent according to claim 17, wherein the composition is a seed treatment composition.

19. The agent according to claim 17, which is a kit comprising a first component comprising (a) prothioconazole or a salt or adduct thereof and a second component comprising (b) trifloxystrobin or a salt or adduct thereof.

20. The agent according to claim 19, wherein the composition is a seed treatment composition.
